(19) United States
(12) Patent Application Publication
(10) Pub. No.: US 2016/0309733 A1
(43) Pub. Date: Oct. 27, 2016

(54) STERILE CHEESE BASE MASS

(71) Applicant: DMK Deutsches Milchkontor GmbH, Zeven (DE)

(72) Inventors: Sven-Rainer Doring, Zeven (DE); Dirk Euwens, Sande (DE); Martin May, Neuenburg (DE)

(21) Appl. No.: 15/133,738

(22) Filed: Apr. 20, 2016

(30) Foreign Application Priority Data
Apr. 25, 2015 (EP) 15165143.7

(51) Int. Cl. A23C 19/06; A23C 3/02; A23C 9/142

(52) U.S. Cl. CPC A23C 19/06; A23C 9/1425; A23C 3/02

(57) ABSTRACT

A sterile cheese base mass is proposed which is obtainable by
(a) subjecting cheese-making milk to a heat treatment and thus creating a first intermediate product,
(b) concentrating the heat-treated first intermediate product and thus creating a liquid cheese base mass as a second intermediate product, and
(c) filling the liquid cheese base mass for further processing into a sterile pack, in which it solidifies.

### FIELD OF THE INVENTION

The invention lies in the field of cheese production and relates to storage-stable cheese base masses and a process for production thereof.

### PRIOR ART

In Europe and the USA, cheese is among the most important basic foods. For the production of cheese, whether it is based on milk or whey, the milk of cattle, buffaloes, sheep or goats, which contains a sufficient quantity of milk protein casein, is used.

If milk is used as the raw material for the production of cheese, the precipitation (coagulation) of the milk protein casein can be effected either by rennet or by acid coagulation or acid precipitation. Through the coagulation of casein, the cheese acquires its firm consistency. Accordingly, a distinction is made between rennet cheese (sweet milk cheese) and sour milk cheese.

In the case of rennet cheese, the curdling is effected by an enzyme mixture of pepsin and chymosin, which is contained in the rennet. With sour milk cheese, casein coagulates due to the lactic acid bacteria. Sour milk cheese is usually cream cheese. However, there is also matured sour milk cheese.

The milk which is processed for cheese production must satisfy strict quality requirements, including the testing of the bacteriological condition of the milk, adjustment of the fat content (addition or removal of cream) and prolonged heating, pasteurization or ultra heat treatment, unless raw milk cheese is to be produced.

The subsequent so-called curdling of the milk also determines which cheese is formed. By acidification by means of lactic acid bacteria (Leuconostoc sp., Lactococcus sp.), cream cheese and matured sour milk cheese are formed. By means of rennet (from calf stomach or produced biotechnologically in fermenters by means of fungi Mucor mihei or Aspergillus niger), hard cheese, slicing cheese, semi-soft slicing cheese and soft cheese are obtained. If rennet is introduced into the milk together with ripening cultures (microorganisms), then this is already curdled after half an hour. This mass is referred to as “coagulum” or “curd”.

In industrial cheese production, the curdled milk is cut into small pieces with the “cheese harp”. Depending on the further processing, this cheese crumb is then carefully further heated, so that the crumb shrinks further (synaresis) and thereby loses still more whey. This procedure is referred to “burning the crumb”. Depending on the cheese type, this takes place at temperatures of up to 55° C. The higher the temperature, the more whey comes out and the higher is the dry mass. The water content and thus the firmness and shelf life of the cheese is influenced by the further processing.

After this, the cheese is made into shapes typical for the given variety. The cheese rounds are formed. By soaking in brine, more water is withdrawn from the edges of the young cheese round and rind formation is prepared for. The salt content of the brine is 15-22%, depending on the cheese variety. Salt also migrates into the cheese and thus also contributes to flavour formation.

An important subject in connection with the production of cheese is its preservation. Many solid cheese varieties receive a protective layer of wax before ripening or are repeatedly rubbed with salt or salt brine, as a result of which the water is drawn out of the outer layers and the hard, dry cheese rind is formed. With correct treatment in combination with red smear, a waxy semisoft rind is formed, which is still air-permeable. This permeability to air imparts to the cheese the prerequisite for being able to ripen correctly. Cheese which ripens in wax with exclusion of air has less character and tastes correspondingly blander. Before dispatch, the cheese rounds are often dipped in paraffin wax. The paraffin wax coating is impermeable to air and is to end the ripening process.

In addition, some national cuisines have developed a range of specialities in order to be able to store less storable cheeses such as cream cheese for longer. In French cuisine, these include Le Pitchou or Crottin de Berry à I'Huile d'Olive, for which oil is poured over cream cheese from goat's milk. However, a common feature to all these known processes is that the storage is limited in time to days up to a few weeks, and should preferably take place in the refrigerated shelf or refrigerator at temperatures below 5° C.

In this connection, reference may be made to EP 1803355 A2 (KRAFT), from which a method for the production of cheese flakes is known, in which a mixture of fats and proteins is heated to 0 to 95° C. and adjusted to a pH in the range from 5.4 to 6, and firstly salts, emulsifiers and additives are added to the mixture, and then in a second step water and fillers. Next, the cheese flakes are bottled and cooled. However, this is again an end product which again in the final analysis has only a limited shelf life.

The purpose of the present invention therefore was to provide preliminary stages for the production of cheese products of a great variety of types, which can easily be processed to the end products, but are protected against spoilage for a markedly longer time compared to the prior art, and can be stored without cooling being required for this.

### DESCRIPTION OF THE INVENTION

A first subject of the invention relates to a sterile cheese base mass, which is obtainable by
(a) subjecting cheese-making milk to a heat treatment and thus creating a first intermediate product,
(b) concentrating the heat-treated first intermediate product and thus creating a liquid cheese base mass as a second intermediate product, and
(c) filling the liquid cheese base mass for further processing into a sterile pack, in which it solidifies.

In a second embodiment, the invention relates to an analogous method for production of a sterile cheese base mass, in which
(a) cheese-making milk is subjected to a heat treatment and a first intermediate product is thus created,
(b) the heat-treated first intermediate product is concentrated and a liquid cheese base mass is thus created as a second intermediate product, and
(c) the liquid cheese base mass is filled for further processing into a sterile pack, in which it solidifies.

Surprisingly, it was found that by sterilization and subsequent concentration of cheese-making milk, especially by filtration methods, a product is obtained which can be filled sterile and then stored over a long period without cooling, and can thereafter easily be converted to a ready-to-eat cheese product.

### Cheese-Making Milk

The term cheese-making milk refers to a raw milk which after pasteurization and fat adjustment is to be curdled for the production of cheese, but also yoghurt. Since cheese production was previously predominantly carried out in vats—which is also to some extent also still typical for the production of Parmesan—the term vat milk is also used as a synonym.

For raw milk to be usable for the production of cheese, it must comply with legal requirements, which are set out in the cheese regulation. Usually, the processing process begins with heating of the raw milk by heat exchange with heat transfer media with simultaneous partial heat recovery. The separation into skim milk, cream and separator sludge is usually performed in a pasteurization unit with integrated separator. During this, the heating is taken far enough for a first heat treatment or pasteurization to occur. After then being standardized, the standardized milk is accumulated in a tank and the accumulated milk withdrawn from the tank is subjected to a second pasteurization by renewed heating.

Alternatively, the cheese-making milk can also be made by the method of EP 2661967 A1 (DMK), by
(a) subjecting raw milk to a heat treatment,
(b) freeing the heat-treated product from solid components,
(c) defatting the resulting intermediate product,
(d) subjecting the skimmed milk thus obtained to a microfiltration and
(e) adjusting the resulting permeate to the desired fat content by addition of a quantity of the cream separated in step (c), and
(f) finally pasteurizing the standardized milk thus obtained.

Preferably cheese-making milk is used which has a fat content of about 10 to about 35 wt. % and in particular about 15 to about 22 wt. % and a protein content of about 15 to about 30 wt. % and in particular about 19 to about 24 wt. %.

### Heat Treatment

In the first step of the method according to the invention, the cheese-making milk is sterilized or pasteurized, i.e. subjected to a heat treatment in the range from about 70 to about 150° C., during which for example it is heated in ultra-high temperature heaters over a period from 1 second to 20 minutes and preferably 5 seconds to 10 minutes. Typical examples are treatments of about 3 to 6 minutes at 120 to 130° C. or 1 to 30 seconds at 135 to 150° C. After this treatment, all thermophilic microbes and enzymes have been killed or inhibited. After this, the heat-treated cheese-making milk is either passed directly into the concentration step or temporarily stored in a sterile tank.

### Concentration

In principle, the concentration can be effected by careful evaporation of the water contained in the cheese-making milk. Preferably however, this is subjected to a microfiltration and/or ultrafiltration and/or nanofiltration for concentration.

These are preferably filtration methods from the membrane technology field, with which macromolecular substances and small particles can be removed from a medium and concentrated. The specific distinction between microfiltration, ultrafiltration and nanofiltration is made via the degree of separation. If the exclusion limit (or also “Cut-off”) is at 100 nm or above, this is described as microfiltration. If the exclusion limit lies in the range between 2 and 100 nm, this is described as ultrafiltration. In nanofiltration, the exclusion limit lies below 2 nm. Each of these cases involves purely physical, i.e. mechanical membrane separation processes, which operate according to the principle of mechanical size exclusion: all particles in the fluids which are larger than the membrane pores are held back by the membrane. The driving force in both separation processes is the differential pressure between inflow and outflow of the filter surfaces, which lies between 0.1 and 40 bar.

The exclusion limits of ultrafiltration membranes are also stated in the form of the NMWC (Nominal Molecular Weight Cut-Off, also MWCO, Molecular Weight Cut Off, unit: Dalton). It is defined as the minimum molecular weight of globular molecules which are 90% retained by the membrane. In practice, the NMWC should be at least 20% lower than the molecular mass of the molecule to be separated. Further qualitative statements concerning the filtration can be made on the basis of the Flux (water equivalent) (transmembrane flow or permeation rate). In the ideal case, this varies proportionately to the transmembrane pressure and reciprocally to the membrane resistance. These quantities are determined both by the properties of the membrane used and also by concentration polarization and any fouling that may occur. The permeation rate is based on 1 m² membrane area. The unit for this is l/(m²hr bar).

Microfiltration is as a rule performed with membranes which have a pore diameter of more than 0.1 μm. For ultrafiltration, membranes which have a pore diameter in the range 0.01 to 0.1 μm (corresponding to a selectivity of about 1,000 to about 50,000 and preferably about 5,000 to about 25,000 Dalton) have been found to be particularly suitable. Nanofiltration prefers pore diameters in the range of less than 0.01 μm (corresponding to a selectivity of about 100 to 5,000 and preferably about 500 to 2,000 Dalton). Preferably membranes with a pore diameter in the range of about 0.01 to about 0.1 mm are used.

The material of the filter surface, both for ultra- and also for nanofiltration, can be stainless steel, polymeric materials, ceramics, aluminium oxide or textile fabrics. There are various forms of filter elements: cartridge filters, flat membranes, spirally wound membranes, bag filters and hollow fibre modules, which are in principle all suitable in the sense of the present invention. Preferably, however, ceramic membranes are used, since these can be cleaned easily and under sterile conditions with steam. Alternatively, metal membranes can be used.

In the sense of the present invention, the filtration processes can be performed “hot” or “cold”, i.e. in the temperature range from about 4 to about 70° C. However, it is preferable to operate at temperatures in the range from about 15 to about 55° C. and in particular about 30 to 40° C., in order to keep the products liquid.

While the permeate is discarded, the residue is further processed. In this manner, the cheese-making milk is adjusted to a dry mass of about 30 to about 60 wt. % and in particular about 35 to about 50 wt. %.

### Final Filling

In the last step of the production process, the still liquid cheese base mass is filled into sterile packs, in which it solidifies. Preferably, these are plastic bags, since a vacuum effect is also associated with the cooling of the liquid mass in the bags, which prevents the penetration of atmospheric oxygen. The filling can take place directly after leaving the concentration stage, i.e. the filtration unit, however the mass can also be passed into a sterile tank beforehand and be temporarily stored there.

Further, it is possible to add further auxiliary agents and additives to the liquid cheese base mass either before or during the filling into the sterile final packaging, as for example in a further embodiment of the present invention it is provided that the foods contain further auxiliary agents and additives, such as for example starter cultures, probiotic microorganisms, rennet, prebiotic substances, emulsifiers, thickeners, food acids, acidity regulators, salts (especially cooking salt), herbs, vitamins, antioxidants, flavourings, flavour enhancers, food dyes and the like, in quantities of for example about 0.1 to about 10 wt. %, preferably about 0.5 to about 8 wt. %, in particular about 1 to about 5 wt. % and particularly preferably about 2 to about 3 wt. % based on the base mass.

### Starter Cultures and Probiotic Microorganisms

Probiotic microorganisms, also referred to as “probiotics”, which constitute the group (N), are live microorganisms which have properties beneficial to the host. According to the FAO/WHO definition, these are “live microorganisms which at appropriate dosage provide a health advantage to the host”. Lactic acid bacteria (LAB) and bifidobacteria are the best known probiotics; however, various yeasts and bacilli can also be used. Probiotics are usually ingested as a component of fermented foods to which specific live cultures have been added, such as for example yoghurt, soya yoghurt or other probiotic foods. In addition, tablets, capsules, powders and sachets which contain the microorganisms in freeze-dried form are also obtainable. Table A gives an overview of normal commercial probiotics which can be used in the sense of the present invention and the corresponding health claims.

TABLE A
Probiotic Substances

| Strain | Name | Producer | Claim |
|---|---|---|---|
| Bacillus coagulans | GanedenBC | Ganeden Biotech | Increases the immune response |
| GBI-30, 6086 | | | in viral infection |
| Bifidobacterium | Probio-Tec | Chr. Hansen | Clinical studies in man have |
| animalis subsp. lactis | Bifidobacterium | | shown that BB-12 alone or in |
| BB-12 | BB-12 | | combination favourably |
| | | | influences the gastrointestinal |
| | | | system. |
| Bifidobacterium | Align | Procter & Gamble | In a preliminary study, it was |
| infantis 35624 | | | shown that the bacterium can |
| | | | decrease abdominal pains. |
| Lactobacillus | | Danisco | From a study, it emerges that |
| acidophilus NCFM | | | the side-effects of antibiotic |
| | | | treatments are decreased |
| Lactobacillus | | | |
| paracasei St11 (or | | | |
| NCC2461) | | | |
| Lactobacillus | | Nestlé | Decreases gastritis symptoms |
| johnsonii La1 | | | and reduces inflammation |
| (=Lactobacillus | | | |
| LC1, Lactobacillus | | | |
| johnsonii NCC533) | | | |
| Lactobacillus | Good Belly/ | Probi | Might improve IBS symptoms; |
| plantarum 299v | ProViva/ProbiMage | | however, still more studies |
| | | | necessary. |
| Lactobacillus | | BioGaia | Initial indications of efficacy |
| reuteri American Type | | | against gingivitis, fever in |
| Culture Collection\|ATTC | | | children and decrease in sick |
| 55730 (Lactobacillus | | | leave in adults. |
| reuteri SD2112) | | | |
| Lactobacillus | | | |
| reuteri Protectis (DSM | | | |
| 17938, daughter strain | | | |
| of ATCC 55730) | | | |
| Lactobacillus | | | |
| reuteri Protectis (DSM | | | |
| 17938, daughter strain | | | |
| of ATCC 55730) | | | |
| Saccharomyces | DiarSafe and | Wren Laboratories | Limited evidence in the |
| boulardii | others | | treatment of acute diarrhoea |
| | | | diseases. |
| Lactobacillus | Bion Flore Intime/ | Chr. Hansen | In one study, evidence of |
| rhamnosus GR-1 | Jarrow Fem- | | efficacy against vaginitis. |
| & Lactobacillus | Dophilus | | |
| reuteri RC-14 | | | |
| Lactobacillus | Florajen3 | American Lifeline, | Initial indications of efficacy |
| acidophilus NCFM | | Inc | against CDAD |
| & Bifidobacterium | | | |
| bifidum BB-12 | | | |
| Lactobacillus | Bio-K+ | Bio-K+ | Indications of improvement in |
| acidophilus CL1285 | CL1285 | International | digestion, particularly with |
| & Lactobacillus | | | regard to lactose intolerance. |
| casei LBC80R | | | |
| Lactobacillus | Bravo Friscus/ | Probi | Studies of efficacy against colds |
| plantarum HEAL 9 & | ProbiFrisk | | are currently in progress. |
| Lactobacillus | | | |
| paracasei 8700: 2 | | | |

Below, two further forms of lactic acid bacteria are mentioned, which can also be used as starter cultures or as probiotics:
Lactobacillus bulgaricus;
Streptococcus thermophilus;
Streptococcus thermophilus,
Leuconostoc species,
Lactococcus lactis subsp. lactis biovar diacetylactis,
Lactococcus lactis subsp. lactis,
Lactococcus lactis subsp. cremoris, and
Bifidobacterium lactis B12,

### Prebiotic Substances

In a further form of the invention, the preparations can further contain prebiotic substances (“prebiotics”), which constitute the group H. Prebiotics are defined as indigestible food components, administration whereof stimulates the growth or the activity of a range of beneficial bacteria in the large intestine. The addition of prebiotic compounds improves the stability of the anthocyanins towards degradation processes in the intestinal tract. Various substances, in particular carbohydrates, which are particularly preferred as prebiotics in the sense of the present invention, are mentioned below.

Fructooligosaccharides. Fructooligosaccharides, or FOS for short, comprise in particular short-chain members with 3 to 5 carbon atoms, such as for example D-fructose and D-glucose. FOS, also referred to as neosugars, are commercially produced on the basis of sucrose and the enzyme fructosyl transferase isolated from fungi. FOS support in particular the growth of bifidobacteria in the intestine and are marketed mainly in the USA together with probiotic bacteria in various functionalized foods.

Inulins. Inulins are among a group of naturally occurring fructose-containing oligosaccharides. They belong to a class of carbohydrates which are described as fructanes. They are isolated from the roots of the chicory plant (Cichorium intybus) or so-called Jerusalem artichokes. Inulins predominantly consist of fructose units and typically have a glucose unit as terminal group. The fructose units are linked together via a beta-(2-1) glycosidic bond. The average degree of polymerization of inulins which are used as prebiotics in the foods sector is about 10 to 12. Inulins also stimulate the growth of bifidobacteria in the large intestine.

Isomaltooligosaccharides. This group is a mixture of alpha-D-linked glucose oligomers, including isomaltose, panose, isomaltotetraose, isomaltopentaose, nigerose, kojibiose, isopanose and higher branched oligosaccharides. Isomaltooligosaccharides are produced via various enzymatic routes. They also stimulate the growth of bifidobacteria and lactobacilli in the large intestine. Especially in Japan, isomaltooligosaccharides are used as food additives in functionalized foods. By now they are also widespread in the USA.

Lactilol. Lactilol is the disaccharide of lactulose. Its medical use is for constipation and in hepatic encephalopathy. In Japan, lactitol is used as a prebiotic. It resists degradation in the upper digestive tract, but is fermented by various intestinal bacteria, which leads to a rise in the biomass of bifidobacteria and lactobacilli in the intestine. Lactitol is also known under the chemical name 4-0-(beta-D-galactopyranosyl)-D-glucitol. Because of the lack of studies, the medical use range of lactitol in the USA is limited; in Europe, it is preferentially used as a sweetener.

Lactosucrose. Lactosucrose is a trisaccharide which is made up of D-galactose, D-glucose and D-fructose. Lactosucrose is produced by enzymatic transfer of the galactosyl residue in the lactose onto the sucrose. It is degraded neither in the stomach nor in the upper part of the intestinal tract, and is exclusively consumed for growth by bifidobacteria. From the physiological viewpoint, lactosucrose acts as a stimulator for the growth of the intestinal flora. Lactosucrose is also known as 4G-beta-D-galactosucrose. It is widespread in Japan as a food additive and as a component of functionalized foods, in particular also as an additive for yoghurts. Lactosucrose is currently also being tested in the USA for a similar use purpose.

Lactulose. Lactulose is a semisynthetic disaccharide of D-lactose and D-fructose. The sugars are linked via a beta-glycosidic bond, which makes them resistant to hydrolysis by digestive enzymes. Instead of this, lactulose is fermented by a limited number of intestinal bacteria, which leads to growth of lactobacilli and bifidobacteria in particular. In the USA, lactulose is a prescription medicine against constipation and hepatic encephalopathy. In Japan, on the other hand, it is freely sold as a food additive and component of functionalized foods.

Pyrodextrins. Pyrodextrins comprise a mixture of glucose-containing oligosaccharides which are formed in the hydrolysis of starch. Pyrodextrins promote the proliferation of bifidobacteria in the large intestine. Also, they are not degraded in the upper intestinal region.

Soya oligosaccharides. This group are oligosaccharides, which essentially are only to be found in soya beans, also in other beans and also peas. The two main members are the trisaccharide raffinose and the tetrasaccharide stachyose. Raffinose is made up of one molecule each of D-galactose, D-glucose and D-fructose. Stachyose consists of two molecules of D-galactose and one molecule each of D-glucose and D-fructose. Soya oligosaccharides stimulate the growth of bifidobacteria in the large intestine and are already used in Japan as food additives and in functionalized foods. In the USA they are currently being tested for this use.

Transgalactooligosaccharides. Transgalactooligosaccharides (TOS) are mixtures of oligosaccharides based on D-glucose and D-galactose. TOS are produced starting from D-lactose by means of the enzyme betaglucosidase from Aspergillus oryzae. Like many other prebiotics, TOS are also stable in the small intestine and stimulate the growth of bifidobacteria in the large intestine. TOS are already marketed as food additives both in Europe and also in Japan.

Xylooligosaccharides. Xylooligosaccharides contain beta-1,4-linked xylose units. The degree of polymerization of the xylooligosaccharides lies between 2 and 4. They are obtained by enzymatic hydrolysis of the polysaccharide xylan. They are already marketed in Japan as food additives; in the USA they are still in the test phase.

Biopolymers. Suitable biopolymers which are also possible as prebiotics, such as for example beta-glucans, are characterized in that they are produced on the basis of plants, for example cereals such as oats and barley, but also fungi, yeasts and bacteria are possible as raw material sources. Also suitable are microbially produced cell wall suspensions or whole cells with a beta-glucan content. Residual proportions of monomers have 1-3 and 1-4 or 1-3 and 1-6 linkages, and the content can vary greatly. Preferably, beta-glucans are obtained on the basis of yeasts, in particular Saccharomyces, especially Saccharomyces cerevisiae. Other suitable biopolymers are chitin and chitin derivatives, in particular oligoglucosamine and chitosan, which is a typical hydrocolloid.

Galactooligosaccharides (GOS). Galactooligosaccharides are made by the enzymatic conversion of lactose, a component of bovine milk. In general, GOS comprise a chain of galactose units which is formed by successive transgalactosylation reactions, and which have a terminal glucose unit. Terminal glucose units are mostly formed by premature hydrolysis of GOS. The degree of polymerization of the GOS can vary quite markedly and ranges from 2 to 8 monomer units. Here, a range of factors determines the structure and the order of the monomer units: the enzyme source, the starting material (lactose concentration and origin of the lactose), the enzymes involved in the process, conditions during the processing and the composition of the medium.

### Emulsifiers

Emulsifiers are characterized by the important property of being soluble both in water and also in fat. Emulsifiers mostly consist of a fat-soluble and a water-soluble part. They are always used when water and oil have to be brought into a stable, homogeneous mixture. Suitable emulsifiers which are used in the food processing industry are selected from: ascorbyl palmitate (E 304), lecithin (E 322), phosphoric acid (E 338), sodium phosphate (E 339), potassium phosphate (E 340), calcium phosphate (E 341), magnesium orthophosphate (E 343), propylene glycol alginate (E 405), polyoxyethylene(8), stearate (E 430), polyoxyethylene stearate (E 431), ammonium phosphatides (E 442), sodium phosphate and potassium phosphate (E 450), sodium salts of the food fatty acids (E 470 a), mono- and diglycerides of food fatty acids (E 471), acetic acid monoglycerides (E 472 a), lactic acid monoglycerides (E 472 b), citric acid monoglycerides (E 472 c), tartaric acid monoglycerides (E 472 d), diacetyltartaric acid monoglycerides (E 472 e), sugar esters of food fatty acids (E 473), sugar glycerides (E 474), polyglycerides of food fatty acids (E 475), polyglycerine polyricinoleate (E 476), propylene glycol esters of food fatty acids (E 477), sodium stearoyllactylate (E 481), calcium stearoyl-2-lactylate (E 482), stearyl tartrate (E 483), sorbitan monostearate (E 491) and stearic acid (E 570).

### Thickeners

Thickeners are substances which first and foremost are capable of binding water.

Through withdrawal of unbound water, an increase in the viscosity occurs. Beyond a concentration characteristic for each thickener, in addition to this effect network effects also occur, which lead mostly to a disproportionate increase in the viscosity. In this case, it is stated that molecules “communicate”, i.e. entangle, with one another. Most thickeners are linear or branched macromolecules (e.g. polysaccharides or proteins) which can interact with one another by intermolecular interactions such as hydrogen bonds, hydrophobic interactions or ionic bonds. Extreme cases of thickeners are layer silicates (bentonites, hectorites) or hydrated SiO₂ particles, which are present dispersed as particles and can bind water in their solid-like structure or can interact with one another on the basis of the said interactions:
E 400—Alginic acid
E 401—Sodium alginate
E 402—Potassium alginate
E 403—Ammonium alginate
E 404—Calcium alginate
E 405—Propylene glycol alginate
E 406—Agar-agar
E 407—Carrageenan, furcelleran
E 407—Locust bean gum
E 412—Guar gum
E 413—Tragacanth
E 414—Gum Arabic
E 415—Xanthan
E 416—Karaya gum (Indian tragacanth)
E 417—Tara gum (Peruvian locust bean meal)
E 418—Gellan
E 440—Pectin, Opekta
E 440ii—Amidated pectin
E 460—Microcrystalline cellulose, cellulose powder
E 461—Methylcellulose
E 462—Ethylcellulose
E463—Hydroxypropylcellulose
E 465—Methylethylcellulose
E 466—Carboxymethylcellulose, sodium carboxymethylcellulose

### Food Acids

The foods can contain carboxylic acids. Acids in the sense of the invention are preferably acids permissible in foods, in particular those mentioned here:
E 260—Acetic acid
E 270—Lactic acid
E 290—Carbon dioxide
E 296—Malic acid
E 297—Fumaric acid
E 330—Citric acid
E 331—Sodium citrate
E 332—Potassium citrate
E 333—Calcium citrate
E 334—Tartaric acid
E 335—Sodium tartrate
E 336—Potassium tartrate
E 337—Sodium potassium tartrate
E 338—Phosphoric acid
E 353—Metatartaric acid
E 354—Calcium tartrate
E 355—Adipic acid
E 363—Succinic acid
E 380—Triammonium citrate
E 513—Sulphuric acid
E 574—Gluconic acid
E 575—Glucono-delta-lactone

### Acid Regulators

Acid regulators are food additives which keep the acidity or the basicity and hence the desired pH of a food constant. These are mostly organic acids and salts thereof, carbonates, and more seldom also inorganic acids and salts thereof. The addition of an acid regulator somewhat reinforces the stability and firmness of the food, causes a desired precipitation and improves the action of preservatives. In contrast to acidifiers, they are not utilized for flavour modification of foods. Their action is based on the formation of a buffer system in the food, with which the pH changes only slightly or not at all on addition of acidic or basic substances. Examples are:
E 170—Calcium carbonate
E 260-263—Acetic acid and acetates
E 270—Lactic acid
E 296—Malic acid
E 297—Fumaric acid
E 325-327—Lactates (lactic acid)
E 330-333—Citric acid and citrates

E 334-337—Tartaric acid and tartrates
E 339-341—Orthophosphates
E 350-352—Malates (malic acid)
E 450-452—Di-, tri- and polyphosphates
E 500-504—Carbonates (carbonic acid)
E 507—Hydrochloric acid and chlorides
E 513-517—Sulphuric acid and sulphates
E 524-528—Hydroxides
E 529-530—Oxides
E 355-357—Adipic acid and adipates
E 574-578—Gluconic acid and gluconates

### Vitamins

In a further embodiment of the present invention, as a further optional group of additives, the food additives can contain vitamins. Vitamins have a great variety of biochemical modes of action. Some act similarly to hormones and regulate the mineral metabolism (e.g. vitamin D), or act on the growth of cells and tissue and cell differentiation (e.g. some forms of vitamin A). Others are antioxidants (e.g. vitamin E and under certain circumstances also vitamin C). The majority of vitamins (e.g. the B vitamins) are precursors for enzymatic cofactors, which support enzymes in catalysing certain processes in the metabolism. In this connection, vitamins can sometimes be tightly bound to the enzymes, for example as part of the prosthetic group: one example of this is biotin, which is a part of the enzyme which is responsible for the construction of fatty acids. On the other hand, vitamins can also be less strongly bound and then act as cofactors, for example as groups which can be easily cleaved off and transport chemical groups or electrons between the molecules. Thus for example folic acid transports methyl, formyl and methylene groups into the cell. Although their support in enzyme-substrate reactions is well known, their other properties are also of great importance to the body.

In the context of the present invention, substances are possible as vitamins which are selected from the group consisting of
Vitamin A (retinol, retinal, beta-carotene),
Vitamin B₁ (thiamine),
Vitamin B2 (riboflavin),
Vitamin B3 (niacin, niacinamide),
Vitamin B5 (pantothenic acid),
Vitamin B₆ (pyridoxine, pyridoxamine, pyridoxal),
Vitamin B7 (biotin),
Vitamin B₉ (folic acid, folinic acid),
Vitamin B12 (cyanocobalamin, hydroxycobalamin, methylcobalamin),
Vitamin C (ascorbic acid),
Vitamin D (cholecalciferol),
Vitamin E (tocopherols, tocotrienols) and
Vitamin K (phylloquinone, menaquinone).
   The preferred vitamins, as well as ascorbic acid, are the group of the tocopherols.

### Antioxidants

In the food industry, both natural and also artificial antioxidants are used. Natural and artificial antioxidants differ first and foremost in that the former occur naturally in the food and the latter are produced artificially. Thus natural antioxidants, so that they can be used as food additives, are for example obtained from plant oils. Vitamin E, also known as tocopherol, is for example often produced from soya oil. Synthetic antioxidants such as propyl gallate, octyl gallate and dodecyl gallate are on the other hand obtained by chemical synthesis. The gallates can trigger allergies in sensitive persons. Further antioxidants usable in compositions of the present invention are: sulphur dioxide, E 220, sulphites sodium sulphite, E 221, sodium hydrogen sulphite, E 222, sodium disulphite, E 223, potassium disulphite, E 224, calcium sulphite, E 226, calcium hydrogen sulphite, E 227, potassium hydrogen sulphite, E 228, lactic acid, E 270, ascorbic acid, E 300, sodium L-ascorbate, E 301, calcium L-ascorbate, E 302, ascorbic acid esters, E 304, tocopherol, E 306, alpha-tocopherol, E 307, gamma-tocopherol, E 308, delta-tocopherol, E 309, propyl gallate, E 310, octyl gallate, E 311, dodecyl gallate, E 312, isoascorbic acid, E 315, sodium isoascorbate, E 316, tertiary-butylhydroquinone (TBHQ), E 319, butylhydroxyanisole, E 320, butylhydroxytoluene, E 321, lecithin, E 322, citric acid, E 330, salts of citric acid (E 331 & E 332) sodium citrate, E 331, potassium citrate, E 332, calcium-disodium EDTA, E 385, diphosphates, E 450, disodium diphosphate, E 450a, trisodium diphosphate, E 450b, tetrasodium diphosphate, E 450c, dipotassium diphosphate, E 450d, tripotassium diphosphate, E 450e, dicalcium diphosphate, E 450f, calcium dihydrogen diphosphate, E 450g, triphosphates, E 451, pentasodium triphosphate, E 451a, pentapotassium triphosphate, E 451b, polyphosphate, E 452, sodium polyphosphate, E 452a, potassium polyphosphate, E 452b, sodium calcium polyphosphate, E 452c, calcium polyphosphate, E 452d, and tin-II chloride, E 512.

### Flavourings

The invention also in particular allows the use of flavourings with ester, aldehyde or lactone structure, which are particularly rapidly degraded in the presence of titanium dioxide and under the influence of light. The invention thus also provides for improved stability, especially storage stability, of the flavourings.

The oral preparations according to the invention can contain one or more flavourings. Typical examples include: acetophenone, allyl capronate, alpha-ionone, beta-ionone anisaldehyde, anisyl acetate, anisyl formate, benzaldehyde, benzothiazole, benzyl acetate, benzyl alcohol, benzyl benzoate, beta-ionone, butyl butyrate, butyl capronate, butylidenephthalide, carvone, camphene, caryophyllene, cineole, cinnamyl acetate, citral, citronellol, citronellal, citronellyl acetate, cyclohexyl acetate, cymol, damascone, decalactone, dihydrocoumarin, dimethyl anthranilate, dimethyl anthranilate, dodecalactone, ethoxyethyl acetate, ethylbutyric acid, ethyl butyrate, ethyl caprinate, ethyl capronate, ethyl crotonate, ethylfuraneol, ethylguaiacol, ethyl isobutyrate, ethyl isovalerate, ethyl lactate, ethyl methylbutyrate, ethyl propionate, eucalyptol, eugenol, ethyl heptylate, 4-(p-hydroxyphenyl)-2-butanone, gamma-decalactone, geraniol, geranyl acetate, geranyl acetate, grapefruit aldehyde, methyl dihydrojasmonate (e.g. Hedion®), heliotropin, 2-heptanone, 3-heptanone, 4-heptanone, trans-2-heptenal, cis-4-heptenal, trans-2-hexenal, cis-3-hexenol, trans-2-hexenoic acid, trans-3-hexenoic acid, cis-2-hexenyl acetate, cis-3-hexenyl acetate, cis-3-hexenyl capronate, trans-2-hexenyl capronate, cis-3-hexenyl formate, cis-2-hexyl acetate, cis-3-hexyl acetate, trans-2-hexyl acetate, cis-3-hexyl formate, para-hydroxybenzylacetone, isoamyl alcohol, isoamyl isovalerate, isobutyl butyrate, isobutyraldehyde, isoeugenol methyl ether, isopropylmethylthiazole, lauric acid, levulinic acid, linalool, linalool oxide, linalyl acetate, menthol, menthofuran, methyl anthranilate, methylbutanol, methylbutyric acid, 2-methylbutyl acetate, methyl capronate, methyl cinnamate, 5-methylfurfural, 3,2,2-methylcyclopentenolone, 6,5,2-methylheptenone, methyl dihydrojasmonate, methyl jasmonate, 2-methylmethylbutyrate, 2-methyl-2-pentenolic acid, methyl thiobutyrate, 3,1-methylthiohexanol, 3-methylthiohexyl acetate, nerol, neryl acetate, trans,trans-2,4-nonadienal, 2,4-nonadienol, 2,6-nonadienol, 2,4-nonadienol, nootkatone, delta octalactone, gamma octalactone, 2-octanol, 3-octanol, 1,3-octenol, 1-octyl acetate, 3-octyl acetate, palmitic acid, paraldehyde, phellandrene, pentanedione, phenylethyl acetate, phenylethyl alcohol, phenylethyl alcohol, phenylethyl isovalerate, piperonal, propionaldehyde, propyl butyrate, pulegone, pulegol, sinensal, sulphurol, terpinene, terpineol, terpinolene, 8,3-thiomenthanone, 4,4,2-thiomethylpentanone, thymol, delta-undecalactone, gamma-undecalactone, valencene, valeric acid, vanillin, acetoin, ethylvanillin, ethylvanillin isobutyrate 3-ethoxy-4-isobutyryloqbenzaldehyde), 2,5-dimethyl-4-hydroxy-3(2H)-furanone and derivatives thereof (but preferably homofuraneol (=2-ethyl-4-hydroxy-5-methyl-3(2H)-furanone), homofuronol (=2-ethyl-5-methyl-4-hydroxy-3(2H)-furanone and 5-ethyl-2-methyl-4-hydroxy-3(2H)-furanone), maltol and maltol derivatives (but preferably ethylmaltol), coumarin and coumarin derivatives, gamma-lactones (but preferably gamma-undecalactone, gamma-nonalactone, gamma-decalactone), delta-lactones (but preferably 4-methyldeltadecalactone, massoia lactone, deltadecalactone, tuberolactone), methyl sorbate, divanillin, 4-hydroxy-2(or 5)-ethyl-5(or 2)-methyl-3(2H)furanone, 2-hydroxy-3-methyl-2-cyclopentenone, 3-hydroxy-4,5-dimethyl-2(5H)-furanone, isoamyl acetate, ethyl butyrate, n-butyl butyrate, isoamyl butyrate, ethyl 3-methylbutyrate, ethyl n-hexanoate, allyl n-hexanoate, n-butyl n-hexanoate, ethyl n-octanoate, ethyl 3-methyl-3-phenylglycidate, ethyl 2-trans-4-cis-decadienoate, 4-(p-hydroxyphenyl)-2-butanone, 1,1-dimethoxy-2,2,5-trimethyl-4-hexane, 2,6-dimethyl-5-hepten-1-al and phenylacetaldehyde, 2-methyl-3-(methylthio)furan, 2-methyl-3-furanthiol, bis(2-methyl-3-furyl) disulphide, furfuryl mercaptan, methional, 2-acetyl-2-thiazoline, 3-mercapto-2-pentanone, 2,5-dimethyl-3-furanthiol, 2,4,5-trimethylthiazole, 2-acetylthiazole, 2,4-dimethyl-5-ethylthiazole, 2-acetyl-1-pyrroline, 2-methyl-3-ethylpyrazine, 2-ethyl-3,5-dimethylpyrazine, 2-ethyl-3,6-dimethylpyrazine, 2,3-diethyl-5-methylpyrazine, 3-isopropyl-2-methoxypyrazine, 3-isobutyl-2-methoxypyrazine, 2-acetyl pyrazine, 2-pentyl pyridine, (E,E)-2,4-decadienal, (E,E)-2,4-nonadienal, (E)-2-octenal, (E)-2-nonenal, 2-undecenal, 12-methyltridecanal, 1-penten-3-one, 4-hydroxy-2,5-dimethyl-3(2H)-furanone, guaiacol, 3-hydroxy-4,5-dimethyl-2(5H)-furanone, 3-hydroxy-4-methyl-5-ethyl-2(5H)-furanone, cinnamaldehyde, cinnamyl alcohol, methyl salicylate, isopulegol and (not explicitly named here) stereoisomers, enantiomers, positional isomers, diastereomers, cis/trans isomers or epimers of these substances.

### Flavour Enhancers

These preparations, like also the flavour mixtures, can further contain additional flavourings to enhance a salty, in some cases slightly acidic and/or umami taste impression. Thus, the products according to the invention or flavouring mixtures are used in combination with at least one further substance suitable for enhancing a pleasant taste impression (salty, umami, optionally slightly acidic). Preferable for this are salty tasting compounds and salt-enhancing compounds. Preferred compounds are disclosed in WO 2007/045566. Also preferred are umami compounds as described in WO 2008/046895 and EP 1 989 944.

Furthermore, flavouring mixtures and products preferred according to the invention can also comprise flavourings for masking bitter and/or astringent taste impressions (taste correctors). The (further) taste correctors are for example selected from the following list: nucleotides (e.g. adenosine-5′-monophosphate, cytidine-5′-monophosphate) or pharmaceutically acceptable salts thereof, lactisols, sodium salts (e.g. sodium chloride, sodium lactate, sodium citrate, sodium acetate, sodium gluconate), further hydroxyflavanones (e.g. eriodictyol, homoeriodictyol or sodium salts thereof), in particular according to US 2002/0188019, hydroxybenzoic acid amides according to DE 10 2004 041 496 (e.g. 2,4-dihydroxybenzoic acid vanillylamide, 2,4-dihydroxybenzoic acid-N-(4-hydroxy-3-methoxybenzyl)amide, 2,4,6-trihydroxybenzoic acid-N-(4-hydroxy-3-methoxybenzyl)amide, 2-hydroxybenzoic acid-N-4-(hydroxy-3-methoxybenzyl)amide, 4-hydroxybenzoic acid-N-(4-hydroxy-3-methoxybenzyl)amide, 2,4-dihydroxybenzoic acid-N-(4-hydroxy-3-methoxybenzyl)amide monosodium salt, 2,4-dihydroxybenzoic acid-N-2-(4-hydroxy-3-meth-oxyphenyl)-ethylamide, 2,4-dihydroxybenzoic acid-N-(4-hydroxy-3-ethoxybenzyl)amide, 2,4-dihydroxybenzoic acid-N-(3,4-dihydroxybenzyl)amide and 2-hydroxy-5-methoxy-N-[2-(4-hydroxy-3-methoxyphenyl)ethyl]amide (Aduncamid), 4-hydroxybenzoic acid vanillylamide), bitter-masking hydroxydeoxybenzoins e.g. according to WO 2006/106023 (e.g. 2-(4-hydroxy-3-methoxyphenyl)-1-(2,4,6-trihydroxyphenyl)ethanone, 1-(2,4-dihydroxyphenyl)-2-(4-hydroxy-3-methoxyphenyl)ethanone, 1-(2-hydroxy-4-methoxyphenyl)-2-(4-hydroxy-3-methoxy-phenyl)ethanone), amino acids (e.g. gamma-aminobutyric acid according to WO 2005/096841 for reducing or masking an unpleasant taste impression such as bitterness), malic acid glycosides according to WO 2006/003107, salty tasting mixtures according to PCT/EP 2006/067120 diacetyl trimers according to WO 2006/058893, mixtures of whey proteins with lecithins and/or bitter-masking substances such as gingerdione according to WO 2007/003527.

Preferred flavourings are those which cause a sweet odour impression, where the flavouring substance or substances which cause a sweet odour impression are preferably selected from the group consisting of:

Vanillin, ethylvanillin, ethylvanillin isobutyrate (=3-ethoxy-4-isobutyryloxy-benzaldehyde, furaneol (2,5-dimethyl-4-hydroxy-3(2H)-furanone) and derivatives (e.g. homofuraneol, 2-ethyl-4-hydroxy-5-methyl-3(2H)-furanone), homofuronol (2-ethyl-5-methyl-4-hydroxy-3(2H)-furanone and 5-ethyl-2-methyl-4-hydroxy-3(2H)-furanone), maltol and derivatives (e.g. ethylmaltol), coumarin and derivatives, gamma-lactones (e.g. gamma-undecalactone, gamma-nonalactone), delta-lactones (e.g. 4-methyldeltalactone, massoia lactone, deltadecalactone, tuberolactone), methyl sorbate, divanillin, 4-hydroxy-2(or 5)-ethyl-5(or 2)-methyl-3(2H)furanone, 2-hydroxy-3-methyl-2-cyclopentenone, 3-hydroxy-4,5-dimethyl-2(5H)-furanone, fruit esters and fruit lactones (e.g. n-butyl acetate, isoamyl acetate, ethyl propionate, ethyl butyrate, n-butyl butyrate, isoamyl butyrate, ethyl 3-methylbutyrate, ethyl n-hexanoate, allyl n-hexanoate, n-butyl n-hexanoate, ethyl n-octanoate, ethyl 3-methyl-3-phenylglycidate, ethyl 2-trans-4-cis-decadienoate), 4-(p-hydroxyphenyl)-2-butanone, 1,1-dimethoxy-2,2,5-trimethyl-4-hexane, 2,6-dimethyl-5-hepten-1-al, 4-hydroxycinnamic acid, 4-methoxy-3-hydroxycinnamic acid, 3-methoxy-4-hydroxycinnamic acid, 2-hydroxycinnamic acid, 2,4-dihydroxybenzoic acid, 3-hydroxybenzoic acid, 3,4-dihydroxybenzoic acid, vanillic acid, homovanillic acid, vanillomandelic acid and phenylacetaldehyde.

### Active Substances for Masking Unpleasant Taste Impressions

Furthermore, the oral preparations can also contain further substances which also serve for masking bitter and/or astringent taste impressions. These further taste correctors are for example selected from the following list: nucleotides (e.g. adenosine-5′-monophosphate, cytidine-5′-monophosphate) or physiologically acceptable salts thereof, lactisols, sodium salts (e.g. sodium chloride, sodium lactate, sodium citrate, sodium acetate, sodium gluconate), hydroxyflavanones, here preferably eriodictyol, sterubin (eriodictyol-7-methyl ether), homoeriodictyol, and sodium, potassium, calcium, magnesium or zinc salts thereof (in particular those as described in EP 1258200 A2, which concerning the relevant compounds disclosed therein by way of reference becomes a component of this application), hydroxybenzoic acid amides, here preferably 2,4-dihydroxybenzoic acid vanillylamide, 2,4-dihydroxybenzoic-acid-N-(4-hydroxy-3-methoxybenzyl)amide, 2,4,6-trihydroxybenzoic acid-N-(4-hydroxy-3-methoxybenzyl)amide, 2-hydroxybenzoic acid-N-4-(hydroxy-3-methoxybenzyl)amide, 4-hydroxybenzoic acid-N-(4-hydroxy-3-methoxybenzyl)amide, 2,4-dihydroxybenzoic acid-N-(4-hydroxy-3-methoxy-benzyl)amide monosodium salt, 2,4-dihydroxybenzoic acid-N-2-(4-hydroxy-3-methoxy-phenyl)ethylamide, 2,4-dihydroxybenzoic acid-N-(4-hydroxy-3-ethoxybenzyl)amide, 2,4-dihydroxybenzoic acid-N-(3,4-dihydroxybenzyl)amide and 2-hydroxy-5-methoxy-N-[2-(4-hydroxy-3-methoxyphenyl)ethyl]amide; 4-hydroxybenzoic acid vanillylamides (in particular those as described in WO 2006/024587, which concerning the relevant compounds disclosed therein by way of reference becomes a component of this application); hydroxydeoxybenzoins, here preferably 2-(4-hydroxy-3-methoxyphenyl)-1-(2,4,6-trihydroxyphenyl)ethanone, 1-(2,4-dihydroxyphenyl)-2-(4-hydroxy-3-methoxyphenyl)-ethanone and 1-(2-hydroxy-4-methoxyphenyl)-2-(4-hydroxy-3-methoxyphenyl)ethanone) (in particular those as described in WO 2006/106023, which concerning the relevant compounds disclosed therein by way of reference becomes a component of this application); hydroxyphenylalkanediones, such as for example gingerdione-[2], gingerdione-[3], gingerdione-[4], dehydrogingerdione-[2], dehydrogingerdione-[3], dehydrogingerdione-[4]) (in particular those as described in WO 2007/003527, which concerning the relevant compounds disclosed therein by way of reference becomes a component of this application); diacetyl trimers (in particular those as described in WO 2006/058893, which concerning the relevant compounds disclosed therein by way of reference becomes a component of this application); gamma-aminobutyric acids (in particular those as described in WO 2005/096841, which concerning the relevant compounds disclosed therein by way of reference becomes a component of this application); divanillins (in particular those as described in WO 2004/078302, which concerning the relevant compounds disclosed therein by way of reference becomes a component of this application) and 4-hydroxydihydrochalconen (preferably as described in US 2008/0227867 A1, which concerning the relevant compounds disclosed therein by way of reference becomes a component of this application), here in particular phloretin and davidigenin, amino acids or mixtures of whey proteins with lecithins, hesperetin as disclosed in WO 2007/014879, which concerning these compounds by way of reference becomes a component of this application, 4-hydroxydihydrochalcones as disclosed in WO 2007/107596, which concerning these compounds by way of reference becomes a component of this application, or propenylphenyl glycosides (chavicol glycosides) as described in EP 1955601 A1, which concerning these compounds by way of reference becomes a component of this application, or extracts from Rubus suavissimus, extracts from Hydrangea macrophylla as described in EP 2298084 A1, pellitorine and derived flavouring compositions as described in EP 2008530 A1, umami compounds as described in WO 2008/046895 A1 and EP 1989944 A1, umami compounds as described in EP 2064959 A1 or EP 2135516 A1, vanillyl lignans, enterodiol, and N-decadienoylamino acids and mixtures thereof.

### Food Colourants

Food colourants or colourants for short are food additives for colouring foods. Colourants are subdivided into the groups of natural colourants and synthetic colourants. The nature-identical colourants are also of synthetic origin. The nature-identical colourants are synthetic copies of colourant substances occurring in nature. Suitable colourants for use in the present composition are selected from: curcumin, E 100, riboflavin, lactoflavin, lactoflavin, vitamin B2, E 101, tartrazine, E 102, quinoline yellow, E 104, yellow orange S, yellow orange RGL, E 110, cochineal, carminic acid, true carmine, E 120, azorubine, carmoisin, E122 amaranth, E123 cochenille red A, Ponceau 4R, Victoria Scarlet 4R, E124, erythrosin, E 127, allura red AC, E 129, patent blue V, E 131, indigotin, indigo-carmine, E 132, brilliant blue FCF, patent blue AE, amido blue AE, E 133, chlorophylls, chlorophyllins, E 140, copper complexes of the chlorophylls, copper-chlorophyllin complexes, E 141, brilliant acid green, green S, E 142, caramel, caramel, E 150 a, sulphite liquor caramel, E 150 b, ammonia caramel, E 150 c, ammonium sulphite caramel, E 150 d, brilliant black FCF, brilliant black PN, black PN, E 151, plant charcoal, E 153, brown FK, E 154, brown HT, E 155, carotene, carotene, E 160 a, annatto, bixin, norbixin, E 160 b, capsanthin, capsorubine, E 160 c, lycopene, E 160 d, beta-apo-8′-carotenal, apocarotenal, beta-apocarotenal, E 160 e, ethyl beta-apo-8′-carotenoate (C30), apocarotene esters, beta-carotenoic acid esters, E 160 f, lutein, xanthophyll, E 161 b, canthaxanthin, E 161 g, betanin, betene red, E 162 anthocyanins, E 163, calcium carbonate, E 170, titanium dioxide, E 171, iron oxides, iron hydroxides, E 172, aluminium, E 173, silver, E 174, gold, E 175 lithol rubine BK, rubine pigment BK, E 180.

### COMMERCIAL APPLICABILITY

A further subject of the invention relates to the use of the cheese base masses according to the invention for the production of ready-to-eat cheese products.

### EXAMPLES

### Example 1

1000 litres of vat milk with a content of 3.3 wt. % fat, 4.3 wt. % lactose and 3.6 wt. % protein were heated and sterilized at 138° C. for 2 seconds by direct injection of steam. The sterile product was subjected to a microfiltration at 45° C. (concentration factor 8), whereby 875 litres of permeate were obtained. The resulting 125 litres of residue were treated with rennet, acid regulator and herbs and curdled. Next, the sterile cheese base mass was filled [into packs].

1. A sterile cheese base mass, obtained by
(a) subjecting cheese-making milk to a heat treatment and thus creating a first intermediate product,
(b) concentrating the heat-treated first intermediate product at a temperature of from about 30 to about 40° C. and thus creating a liquid cheese base mass as a second intermediate product, and
(c) filling the liquid cheese base mass for further processing into a sterile pack, in which it solidifies.

2. A process for production of a sterile cheese base mass, comprising the following steps:
(a) subjecting cheese-making milk to a heat treatment and a first intermediate product is thus created,
(b) concentrating the heat-treated first intermediate product of step (a) at a temperature of from about 30 to about 40° C. and a liquid cheese base mass is thus created as a second intermediate product, and
(c) filling the liquid second intermediate product of step (b) into a sterile pack, in which it solidifies.

2. The process according to claim 2, wherein cheese-making milk is used which has a fat content of about 10 to about 35 wt. % and a protein content of about 15 to about 30 wt. %.

4. The process according to claim 2, wherein the cheese-making milk is subjected to a heat treatment at about 70 to about 150° C.

5. The process according to claim 2, wherein the cheese-making milk is subjected to a heat treatment over a period from about 5 seconds to about 20 minutes.

6. The process according to claim 2, wherein the heat-treated cheese-making milk is temporarily stored in a sterile tank before the concentration.

7. The process according to claim 2, wherein for the concentration the cheese-making milk is subjected to a microfiltration and/or ultrafiltration and/or nanofiltration.

8. The process according to claim 7, wherein the filtration is performed using a ceramic membrane.

9. The process according to claim 7, wherein the filtration is performed using a metal membrane.

10. The process according to claim 7, wherein the filtration is performed using membranes which have a pore size from 0.01 to about 0.1 mm.

11. The process according to claim 7, wherein the filtration is performed at a temperature in the range from 4 to 70° C.

12. The process according to claim 2, wherein the cheese-making milk is adjusted to a dry mass of about 30 to about 60 wt. %.

13. The process according to claim 2, wherein the liquid cheese base mass is temporarily stored in a sterile tank before the final filling.

14. The process according to claim 2, wherein further auxiliary agents and additives are added to the liquid cheese base mass either before or during the filling into the sterile final packaging.

15. (canceled)
